(19) United States
(12) Patent Application Publication
(10) Pub. No.: US 2013/0207492 A1
(43) Pub. Date: Aug. 15, 2013

(54) ELECTRIC MACHINE MODULE COOLING SYSTEM AND METHOD

(71) Applicants: Bradley D. Chamberlin, Pendleton, IN (US); Colin J. Hamer, Noblesville, IN (US); Ted Garcia, Noblesville, IN (US); Eric Babb, Anderson, IN (US); Chad Zook, Anderson, IN (US); Tom Merrill, Noblesville, IN (US); Tom Beaty, Anderson, IN (US)

(72) Inventors: Bradley D. Chamberlin, Pendleton, IN (US); Colin J. Hamer, Noblesville, IN (US); Ted Garcia, Noblesville, IN (US); Eric Babb, Anderson, IN (US); Chad Zook, Anderson, IN (US); Tom Merrill, Noblesville, IN (US); Tom Beaty, Anderson, IN (US)

(21) Appl. No.: 13/370,673

(22) Filed: Feb. 10, 2012

(51) Int. Cl. H02K 5/20; H02K 3/38; H02K 15/02; H02K 3/34

(52) U.S. Cl. 310/59; 310/215; 29/596

(57) ABSTRACT

Embodiments of the invention provide an electric machine module including a housing. The housing can include a machine cavity. In some embodiments, an electric machine can be at least partially positioned within the machine cavity and can include a stator assembly. The stator assembly includes a stator core with slots. In some embodiments, conductors can be positioned in the slots. The conductors include a turn portion extending between leg portions. The leg portions include an angled portion and a connection portion. The conductors are disposed within the plurality of slots so that the angled and connection portions extend from the stator core at a first axial side. At least one insulation member can be disposed over at least some of the leg portions so that the connection portions are at least partially uncovered.

### BACKGROUND

Some conventional electric machines include a stator assembly disposed around a rotor assembly. Some stator assemblies include a plurality of conductors positioned within a stator core. During operation of some electric machines, a current flows through the at least some of the conductors. In order to prevent potential short circuit events and or grounding incidents, some conventional configurations for stator assemblies require multiple insulation layers between and amongst the conductors. Moreover, during operation of some electric machines, heat energy can be generated by both the stator assembly and the rotor assembly, as well as some other components of the electric machine. The increase in heat energy produced by some elements of the electric machine can lead to inefficient machine operations.

### SUMMARY

Some embodiments of the invention provide an electric machine module including a housing. The housing can include a machine cavity. In some embodiments, an electric machine can be at least partially positioned within the machine cavity and can include a stator assembly. The stator assembly can include a stator core with slots. The stator core can include a first axial end and a second axial end. In some embodiments, conductors can be positioned in at least some of the slots. In some embodiments, the conductors can include a turn portion extending between leg portions. The leg portions can include an angled portion and a connection portion. In some embodiments, conductors can be positioned within the plurality of slots so that the angled portions and the connection portions extend from the stator core at the first axial end and the turn portions extend from the stator core at the second axial end. In some embodiments, at least one insulation member can be disposed over one or more of the leg portions extending from the stator core at the first axial side so that the connection portions are at least partially uncovered by the insulation members, and at least some of the angled portions are at least partially covered by the insulation members.

Some embodiments of the invention provide an electric machine module including a housing. The housing can include a machine cavity. In some embodiments, an electric machine can be at least partially positioned within the machine cavity and can include a stator assembly. The stator assembly can include a stator core with slots. In some embodiments, the stator assembly can comprise an insertion end and a weld end, and at least one slot member can be disposed in at least a portion of the slots. In some embodiments, a plurality of conductors can be disposed in at least some of the plurality of slots so that the conductors are at least partially disposed within the slot members. In some embodiments, the conductors can include a first portion extending from the weld end and a second portion extending from the insertion end. The first portion can comprise at least a connection portion and an angled portion. In some embodiments, at least one half of the slot members are configured and arranged to extend from a point substantially adjacent to the connection portions toward a point substantially adjacent to the second portions of the plurality of conductors.

### DESCRIPTION OF THE DRAWINGS

FIG. 1 is a perspective view of an electric machine module according to one embodiment of the invention.

FIG. 2 is a perspective view of an electric machine module according to one embodiment of the invention.

FIG. 3 is a perspective view of a stator assembly according to one embodiment of the invention.

FIG. 4 is front view of a stator lamination according to one embodiment of the invention.

FIG. 5 is a perspective view of a conductor according to one embodiment of the invention.

FIGS. 6A and 6B are cross-sectional views of a slot according to some embodiments of the invention.

FIG. 7 is a perspective view of a stator assembly according to some embodiments of the invention.

FIG. 8 is an perspective view of a stator assembly including twisted conductors according to some embodiments of the invention.

FIG. 9 is an perspective view of a stator assembly including twisted conductors according to some embodiments of the invention.

FIG. 10 is an perspective view of a stator assembly including twisted conductors according to some embodiments of the invention.

FIG. 11 is a perspective view of a stator assembly according to some embodiments of the invention.

FIG. 12 is an perspective view of a stator assembly including twisted conductors according to some embodiments of the invention.

FIG. 13 is a side view of two insulation members according to one embodiment of the invention.

FIG. 14 is a partial cross-sectional view of a stator assembly according to one embodiment of the invention.

FIG. 15 is a side view of a portion of a stator assembly according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

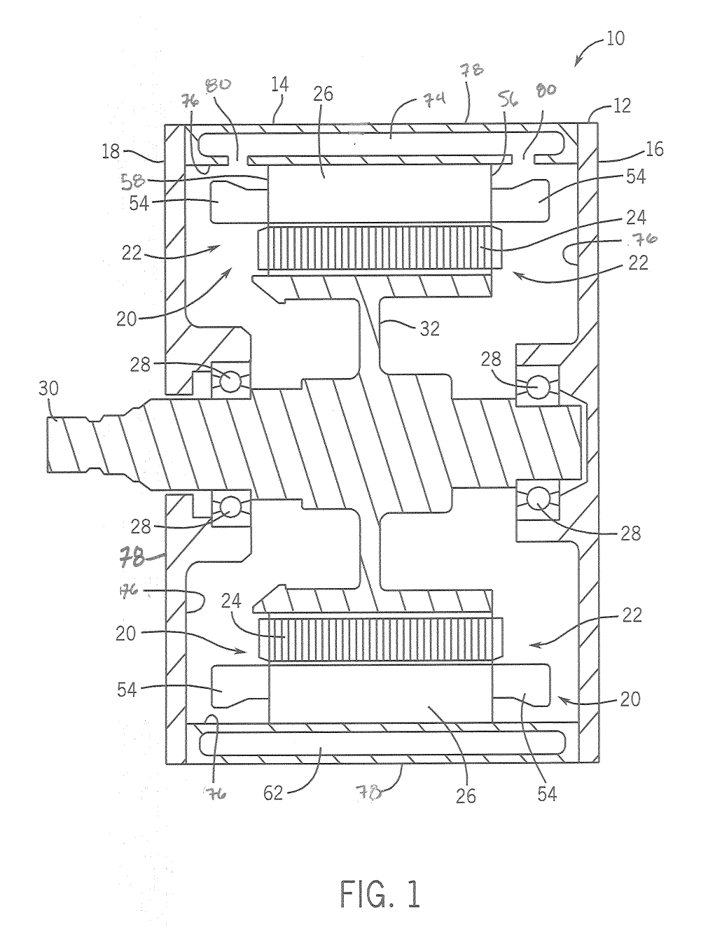

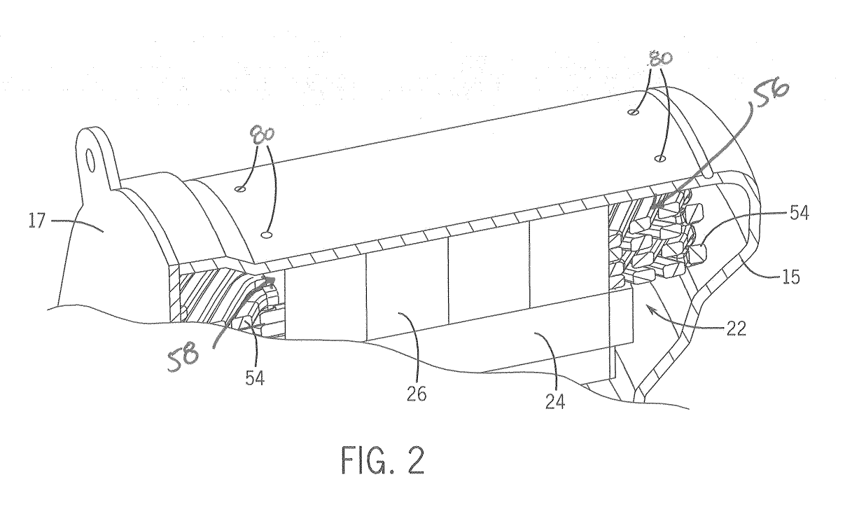

FIGS. 1 and 2 illustrate an electric machine module 10 according to one embodiment of the invention. The module 10 can include a housing 12 comprising a sleeve member 14, a first end cap 16, and a second end cap 18. An electric machine 20 can be housed within a machine cavity 22 at least partially defined by the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments, the housing 12 can comprise a substantially cylindrical canister 15 coupled to an end cap 17, as shown in FIG. 2. Further, in some embodiments, the housing 12 can comprise materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can include a rotor assembly 24, a stator assembly 26, and bearings 28, and can be disposed about a shaft 30. As shown in FIG. 1, the stator assembly 26 can substantially circumscribe at least a portion of the rotor assembly 24. In some embodiments, the rotor assembly 24 can also include a rotor hub 32 or can have a “hub-less” design (not shown).

In some embodiments, the electric machine 20 can be operatively coupled to the housing 12. For example, the electric machine 20 can be fit within the housing 12. In some embodiments, the electric machine 20 can be fit within the housing 12 using an interference fit, a shrink fit, other similar friction-based fits that can at least partially operatively couple the machine 20 and the housing 12. For example, in some embodiments, the stator assembly 26 can be shrunk fit into the module housing 12. Further, in some embodiments, the fit can at least partially secure the stator assembly 26, and as a result, the electric machine 20, in axial, radial and circumferential directions. In some embodiments, during operation of the electric machine 20 the fit between the stator assembly 26 and the housing 12 can at least partially serve to transfer torque from the stator assembly 26 to the housing 12. In some embodiments, the fit can result in a generally greater amount of torque retained by the module 10.

The electric machine 20 can be, without limitation, an electric motor, such as a hybrid electric motor, an electric generator, or a vehicle alternator. In one embodiment, the electric machine 20 can be a High Voltage Hairpin (HVH) electric motor, an interior permanent magnet electric motor, or an induction motor for hybrid vehicle applications.

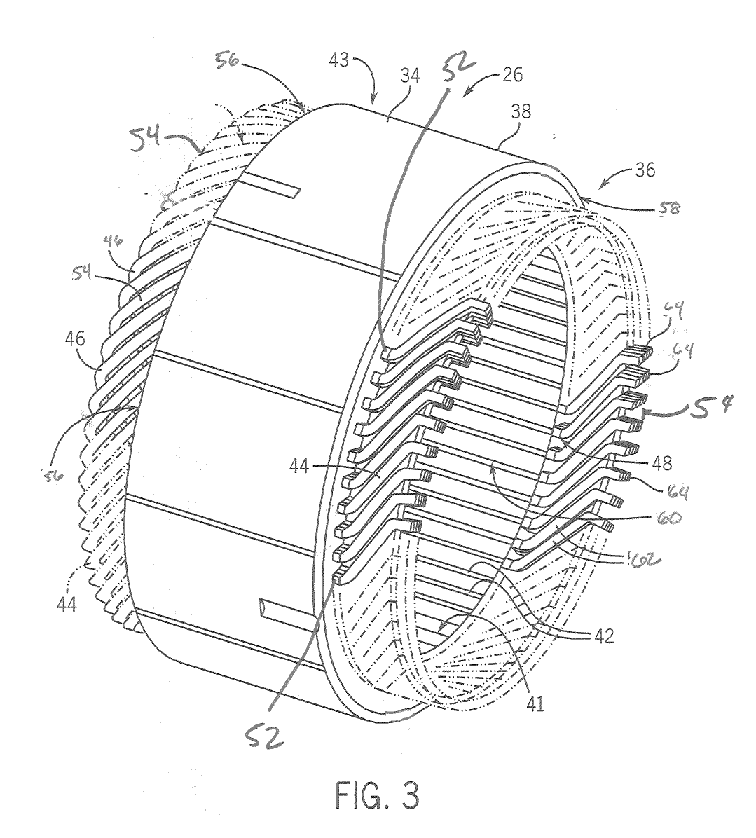

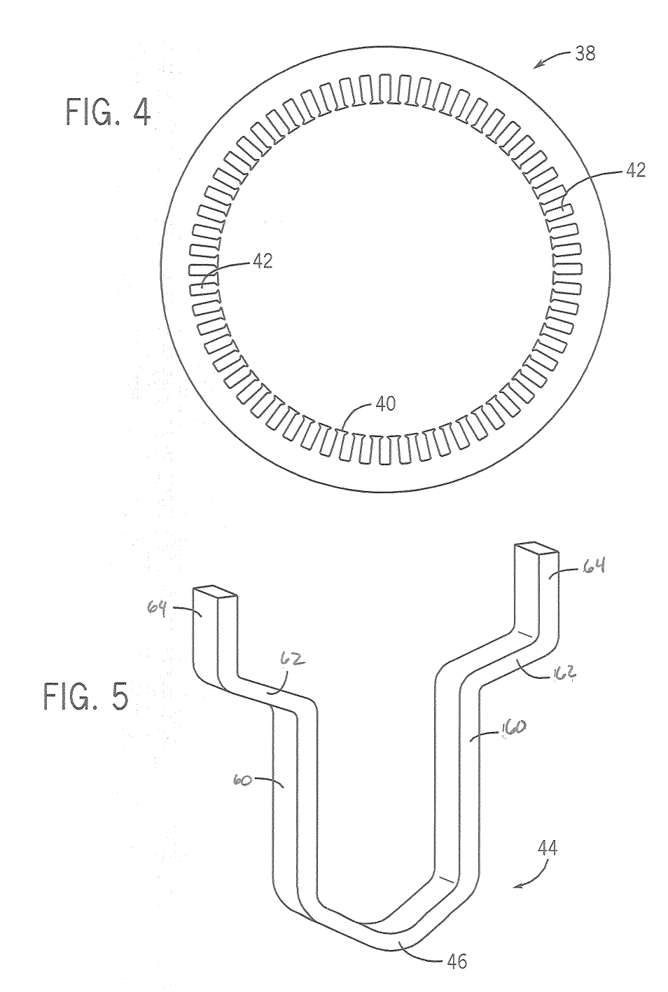

As shown in FIG. 3, in some embodiments, the stator assembly 26 can comprise a stator core 34 and a stator winding 36 at least partially disposed within a portion of the stator core 34. For example, in some embodiments, the stator core 34 can comprise a plurality of laminations 38. Referring to FIG. 4, in some embodiments, the laminations 38 can comprise a plurality of substantially radially-oriented teeth 40. In some embodiments, as shown in FIG. 3, when at least a portion of the plurality of laminations 38 are substantially assembled, the teeth 40 can substantially align to define a plurality of slots 42 that are configured and arranged to support at least a portion of the stator winding 36. As shown in FIG. 4, in some embodiments, the laminations 38 can include sixty teeth 40, and, as a result, the stator core 28 can include sixty slots 42. In other embodiments, the laminations 38 can include more or fewer teeth 40, and, accordingly, the stator core 34 can include more or fewer slots 42. Moreover, in some embodiments, the stator core 34 can comprise an inner perimeter 41 and an outer perimeter 43. For example, in some embodiments, the stator core 34 can comprise a substantially cylindrical configuration so that the inner and outer perimeters 41, 43 can comprise inner and outer diameters, respectively. However, in other embodiments, the stator core 34 can comprise other configurations (e.g., square, rectangular, elliptical, regular or irregular polygonal, etc.), and, as a result, the inner and outer perimeters 41, 43 can comprise other dimensions.

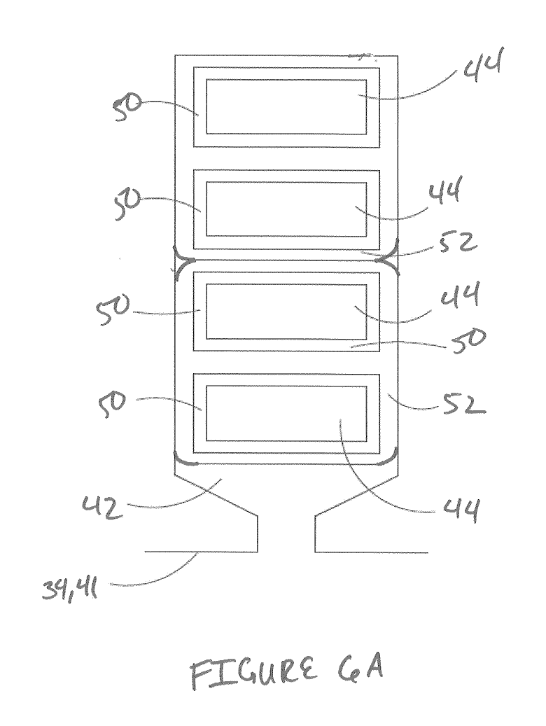

In some embodiments, the stator winding 36 can comprise a plurality of conductors 44. In some embodiments, the conductors 44 can comprise a substantially segmented configuration (e.g., a hairpin configuration), as shown in FIGS. 3 and 5. For example, in some embodiments, at least a portion of the conductors 44 can include a turn portion 46 and at least two leg portions 48. In some embodiments, the turn portion 46 can be disposed between the two leg portions 48 to substantially connect the two leg portions 48. In some embodiments, the leg portions 48 can be substantially parallel. Moreover, in some embodiments, the turn portion 46 can comprise a substantially “u-shaped” configuration, although, in some embodiments, the turn portion 46 can comprise a v-shape, a wave shape, a curved shape, and other shapes. Additionally, in some embodiments, as shown in FIG. 5, at least a portion of the conductors 44 can comprise a substantially rectangular cross section. In some embodiments, at least a portion of the conductors 44 can comprise other cross-sectional shapes, such as substantially circular, square, hemispherical, regular or irregular polygonal, etc. In some embodiments, the conductors 44 can comprise other configurations (e.g., substantially non-segmented configuration).

In some embodiments, the stator assembly 26 can comprise one or more insulating members, apparatuses, and/or other structures configured and arranged to provide mechanical, electrical, and physical insulation to some portions of the stator assembly 26. In some embodiments, at least a portion of some of the conductors 44 can comprise a first insulation 50. For example, in some embodiments, the first insulation 50 can comprise a resinous material such as an epoxy or an enamel that can be reversibly or irreversibly coupled to at least a portion of the conductors 44. In some embodiments, because an electrical current circulates through the conductors 44 during operation of the electric machine 20, the first insulation 50 can function, at least in part, to substantially prevent short circuits and/or grounding events between neighboring conductors 44 and/or conductors 44 and the stator core 34.

In some embodiments, the first insulation 50 can comprise a shrunk-fit structure coupled to at least some of the conductors 44 so that the first insulation 50 is retained when the conductors 44 are disposed within the stator core 28. In some embodiments, the first insulation 50 can be wrapped, wound, or otherwise disposed on, or coupled to, the conductors (e.g., via an adhesive). In some embodiments, as discussed further below, at least a portion of the conductors 44 can substantially function without some or all of the first insulation 50.

In some embodiments, the conductors 44 can be generally fabricated from a substantially linear conductor 44 that can be configured and arranged to a shape substantially similar to the conductor in FIG. 5. For example, in some embodiments, a machine (not shown) can apply a force (e.g., bend, push, pull, other otherwise actuate) to at least a portion of a conductor 44 to substantially form the turn portion 46 and the two leg portions 48 of a single conductor 44. In some embodiments, at least a portion of the conductors 44 can be configured into a desired shape after coupling of the first insulation 50 to the conductors 44. Although, in some embodiments, at least a portion of the conductors 44 can be configured (e.g., bent, pushed, pulled, etc.) into a desired shape (e.g., a hairpin) and then the first insulation 50 can be coupled to the conductors 44.

In some embodiments, the stator assembly 26 can comprise a second layer of insulation. In some embodiments, the second layer of insulation can comprise at least one slot member 52. In some embodiments, the stator assembly 26 can comprise at least one slot member 52 disposed in one or more of the slots 42. For example, one or more slot members 52 can be disposed in some or all of the slots 42. In some embodiments, each slot 42 can comprise at least one slot member 52. In some embodiments, at least a portion of the slot members 52 can comprise a substantially cylindrical shape. In some embodiments, the slot members 52 can comprise other shapes, such as square, rectangular, hemispherical, regular or irregular polygonal, etc. In some embodiments, at least a portion of the slot members 52 can comprise any shape desired and/or needed by the manufacturer or user. Moreover, in some embodiments, the slot members 52 can be configured and arranged to receive at least a portion of one or more conductors 44, as described in further detail below.

In some embodiments, the slot member 52 can comprise materials that can resist abrasion, can provide electrical and/or mechanical insulation, can comprise thermally-conductive properties, and/or can comprise other properties desired by a manufacturer or user. For example, in some embodiments, at least a portion of the slot members 52 can comprise materials such as polyimides (e.g., Kapton®), polyamides, polyester, polyamideimide, polyethylene terephthalate film (e.g., Mylar®), para-aramid (e.g., Kevlar®), meta-aramid (e.g., Nomex®) or other materials. In some embodiments, the slot member 52 can comprise a composite of some or all of the previously mentioned materials, such as a Nomex®-Katpton® composite.

In some embodiments, as shown in FIG. 3, at least a portion of the conductors 44 can be positioned substantially within the slots 42. For example, in some embodiments, the stator core 34 can be configured so that the plurality of slots 42 are substantially axially arranged. In some embodiments, the leg portions 48 can be inserted into the slots 42 so that at least some of the leg portions 48 can axially extend through the stator core 34. In some embodiments, the leg portions 48 can be inserted into neighboring slots 42. For example, in some embodiments, the leg portions 48 of a conductor 44 can be disposed in slots that are distanced approximately one magnetic-pole pitch apart (e.g., six slots, eight slots, etc.). In some embodiments, a plurality of conductors 44 can be disposed in the stator core 34 so that at least some of the turn portions 46 of the conductors 44 axially extend from the stator core 34 at an insertion end 56 of the stator assembly 26 and at least some of the leg portions 48 axially extend from the stator assembly 26 at a weld end 58 of the stator core 34. In some embodiments, at least a portion of the conductor 44 regions that axially extend from the stator assembly 26 at the ends 56, 58 can comprise stator end turns 54.

In some embodiments, one or more slot members 52 can be disposed within some or all of the slots 42 during assembly of the module 10. In some embodiments, the slot members 52 can be disposed within the slots 42 prior to one or more of the conductors 44 being disposed within the stator core 34. For example, in some embodiments, the slot members 52 can be positioned within the slots 42 so that at least a portion of some of the conductors 44 (e.g., the leg portions 48) can be at least partially disposed within the slot members 52. By way of example only, in some embodiments, one or more slot members 52 can be disposed within each of the slots 42 so that the slot members 52 can receive at least a portion of each of the conductors 44.

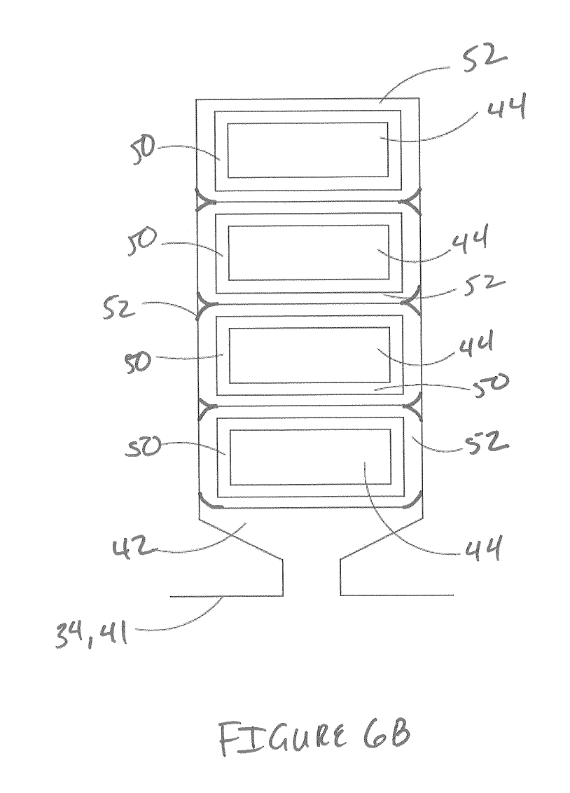

Moreover, in some embodiments, one slot member 52 can receive one or more conductors. In some embodiments, one slot member 52 can be configured and dimensioned to receive two or more conductors 44. For example, in some embodiments, at least a portion of the slot members 52 can be configured and arranged to receive two conductors (e.g., a leg portion 48 of two different conductors 44 or both leg portions 48 of the same conductor 44), as shown in FIG. 6A. As a result, in some embodiments, at least a portion of the slots 42 can comprise four conductors 44 and two slot members 52 (e.g., portions of two conductors 44 disposed in a slot member 52). In some embodiments, at least a portion of the slots 42 can comprise the same number of slot members 52 as conductors 44. For example, in a slot 42 including portions of four conductors 44, the slot 42 can comprise four or more slot members 52, as shown in FIG. 6B. Furthermore, in some embodiments, the stator assembly 26 can comprise any combination of any of the foregoing slot member 52/conductor 44 ratios. For example, some slots 42 can comprise four slot members 52 and four conductors 44, some slots 42 can comprise two slot members 52 and four conductors 44, and some slots can comprise one or more than one slot members 52 and four conductors 44. As previously mentioned, the use of four conductors 44 is exemplary and other number of conductors 44 (e.g., one, two, six, eight, etc.) can be disposed within the slots 42.

In some embodiments, at least some of the leg portions 48 can comprise multiple regions. In some embodiments, the leg portions 48 can comprise in-slot portions 60, angled portions 62, and connection portions 64. In some embodiments, as previously mentioned, the leg portions 48 can be disposed in the slots 42 and some regions of the leg portions 48 (e.g., the in-slot portions 60) can be at least partially received within the slot members 52. Moreover, the leg portions 48 can axially extend from the insertion end 56 to the weld end 58. In some embodiments, after insertion, at least a portion of the leg portions 48 positioned within the stator core 34 can comprise the in-slot portions 60.

In some embodiments, at least some regions of the leg portions 48 extending from stator assembly 26 at the weld and insertion ends 56, 58 can comprise the angled portions 62 and the connection portions 64. In some embodiments, after inserting the conductors 44 into the stator core 34, the leg portions 48 extending from the stator core 34 can undergo a conventional twisting process (not shown) which can lead to the creation of the angled portions 62 and the connection portions 64. For example, in some embodiments, the twisting process can locate the angled portions 62 at a more axially inward position and the connection portions 64 at a more axially outward position, as shown in FIG. 3. In some embodiments, the angled portions 62 can comprise other configurations, such as bent, curved, or otherwise removed from a horizontal axis of the conductors 44.

In some embodiments, after the twisting process, the connection portions 64 of at least a portion of the conductors 44 can be immediately adjacent to connection portions 64 of other conductors 44. As a result, the connection portions 64 can be coupled together to form one or more stator windings 36. In some embodiments, the connection portions 64 can be coupled via welding, brazing, soldering, melting, adhesives, or other coupling methods. Additionally, in some embodiments, at least a portion of the first insulation 50 can be substantially removed at the connection portions 64 in order to enable the coupling process. Although, in some embodiments, the first insulation 50 can be coupled to the conductors 44 so that it does not coat and/or cover the connection portions 64.

In some embodiments, the stator assembly 26 can comprise other configurations. For example, the conductors 44 can comprise a substantially linear configuration (e.g., the conductors 44 can be dimensioned to function without a turn portion 46). The conductors 44 can be inserted into the stator core 34 substantially similar some previously embodiments. In some embodiments, after positioning at least a portion of the conductors 44, the leg portions 48 extending from the ends 56, 58 of the stator core 34 can twisted to comprise connection portions 64 and angled portions 62 on both sides of the stator assembly 26. As a result, neighboring connection portions 64 on the ends 56, 58 of the stator assembly 26 can be connected together to form one or more stator windings 36 in a double-coupling configuration (not shown).

In some embodiments, the first insulation 50 can at least partially wear down as a result of the twisting process. For example, in some embodiments, pressure points created by the twisting process can create areas of the first insulation 50 that receive more mechanical stress relative to other portions of the first insulation 50. Over the course of the life of the module 10, the first insulation 50 can wear, and, under some circumstances, the first insulation 50 can eventually become compromised. As a result of wear of the first insulation 50, in some embodiments, bare conductors 44 (e.g., bare copper or bare copper-containing materials) can contact each other, the stator core 34, the housing 12, or other elements, which can lead to malfunctioning of the module 10 (e.g., short circuit events, grounding events, etc.).

Furthermore, in some embodiments, module 10 operations can be improved if an axial length of the stator end turns 54 is minimized so that the overall size of the electric machine module 10 can be reduced. For example, in some embodiments, the leg portions 48 can be twisted to a greater extent (e.g. the connection portions 64 can be moved a greater circumferential distance and axially inward) so that the angled regions 62 can be disposed closer to the stator core 34 (e.g., the angled regions 62 can be disposed at a greater angle relative to a horizontal axis of the stator core 34) relative to other embodiments. As a result, the axial length of the stator assembly 26 can comprise a lesser length relative to some embodiments where the leg portions 48 are twisted to a lesser extent. In some embodiments, as a result of increasing the extent of twisting and disposing the angled regions 62 closer to the stator core 34, portions of the conductors 44 can be positioned substantially adjacent to each other (e.g., touching or almost touching each other). As a result, over the life of the module 10, the conductors 44 can contact each other, which can lead to wearing of the first insulation 50, resulting in short circuits, grounding events, and other malfunctions and/or failures of the module 10.

In some embodiments, the stator assembly 26 can comprise at least one insulation member 66. In some embodiments, the stator assembly 26 can comprise a plurality of insulation members 66. In some embodiments, at least a portion of the insulation members 66 can comprise substantially similar materials to the slot member 52. For example, the insulation members 66 can comprise a Nomex®-Kapton® composite, although in other embodiments, at least some of the insulation members 66 can comprise alternative materials, as previously mentioned with respect to the slot members 52.

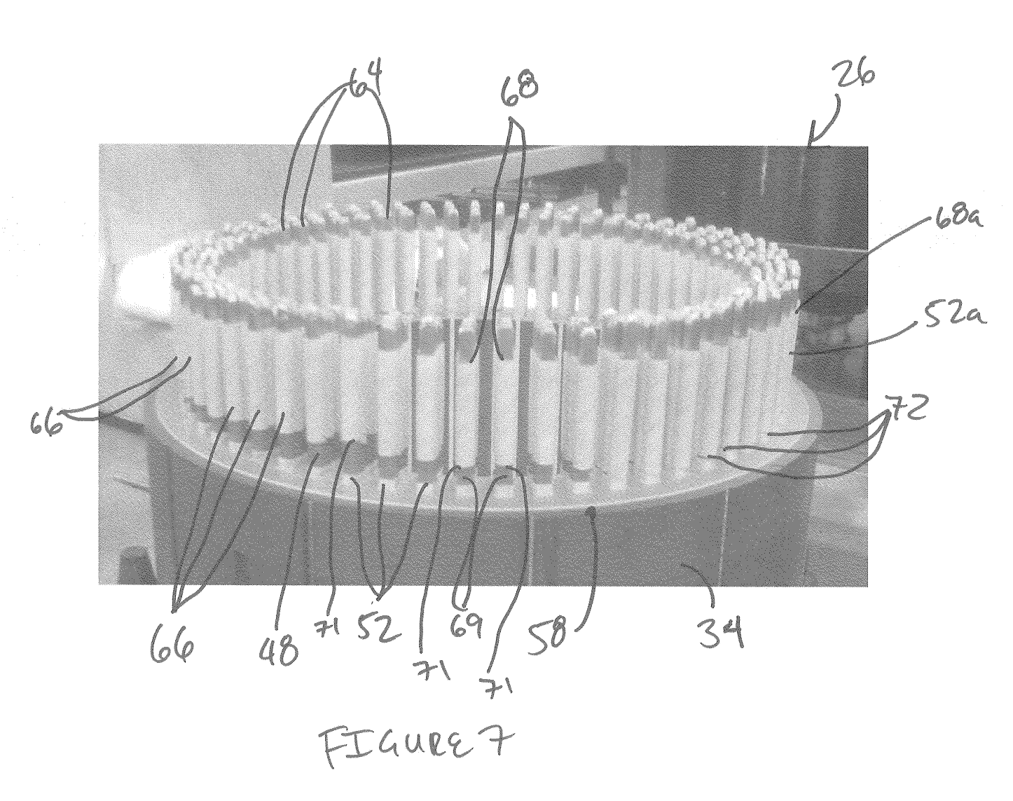

In some embodiments, at least one of the insulation members 66 can be positioned so that it covers at least a portion of at least one conductor 44. For example, in some embodiments, as shown in FIG. 7, at least a portion of the insulation members 66 can be disposed over at least some of the leg portions 48 and/or turn portions 46 of the conductors 44. Moreover, in some embodiments, the insulation members 66 can be disposed on some or all of the leg portions 48 of the conductors 44 that extend from the weld end 58 of the stator assembly 26. Additionally, in some embodiments, the insulation members 66 can be disposed over some portions of the conductors 44 that extend from the stator assembly 26 at the insertion end 56 in addition to, or in lieu of, being disposed over some portions of the conductors 44 that extend from the weld end 58. As described in further detail below, at least some of the insulation members 66 can be configured and arranged to reduce the risk of module 10 malfunctions and failures due to conductor 44 contact with other conductors 44, the stator core 34, the housing 12, etc.

In some embodiments, at least a portion of the insulation members 66 can be configured and arranged to receive at least a portion of a conductor 44. In some embodiments, at least a portion of the insulation members 66 can be shaped and dimensioned so that at least a portion of some of the conductors 44 can fit within the insulation members 66. For example, in some embodiments, at least a portion of the insulation members 66 can comprise a tube shape, a cylindrical configuration, or other shapes and configurations (e.g., square, rectangular, etc.). In some embodiments, the insulation members 66 can comprise any other shape that can receive at least a portion of the conductors 44.

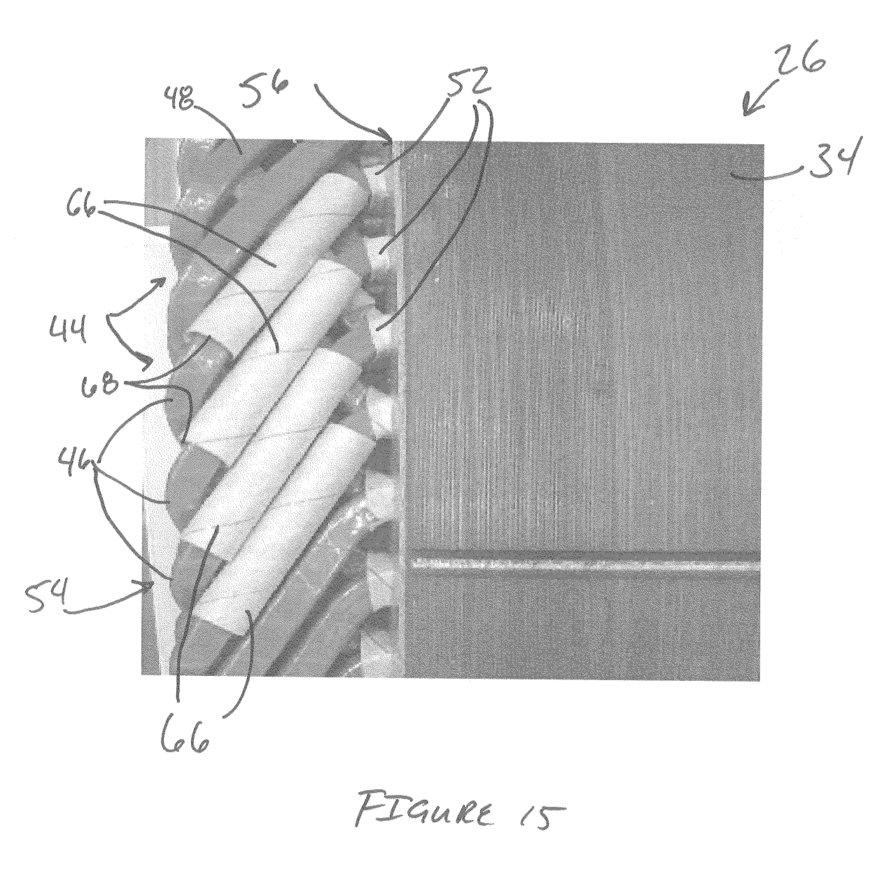

In some embodiments, after inserting at least a portion of the conductors 44 within the stator core 34 (e.g., inserting the leg portions 48 so that the in-slot portions 60 are within the slots 42) some insulation members 66 can be positioned over at least some of the leg portions 48 extending from the weld end 58 prior to twisting, as shown in FIG. 7. Moreover, as previously mentioned, in addition to, or in place of the leg portions 48 extending from the weld end 58, in some embodiments, at least some of the insulation members 66 can be positioned over at least some portions of the conductors 44 that extend from the insertion end 56 of the stator assembly 26, as shown in FIG. 15. For example, as shown in FIG. 15, the insulation members 66 can be positioned so that at least a portion of the insulation members 66 extend from a point substantially adjacent to the turn portion 46 to a point substantially adjacent to the stator core 34. In other embodiments, the insulation members 66 can cover a substantial portion of at least some of the conductors 44 extending from the stator core 34 at the insertion end 56 (e.g., the insulation member 66 can cover a substantial portion of the leg portions 48 and turn portion 46 of some or all of the conductors 44 extending from the stator core 34 at the insertion end 56).

In some embodiments, at least a portion of the insulation members 66 can be positioned during the assembly process. For example, in some embodiments, at least a portion of the insulation members 66 can be substantially automatically positioned (e.g., by a machine) over portions of the conductors 44. In some embodiments, at least a portion of the insulation members 66 can be positioned by a manual process (e.g., by hand assembly).

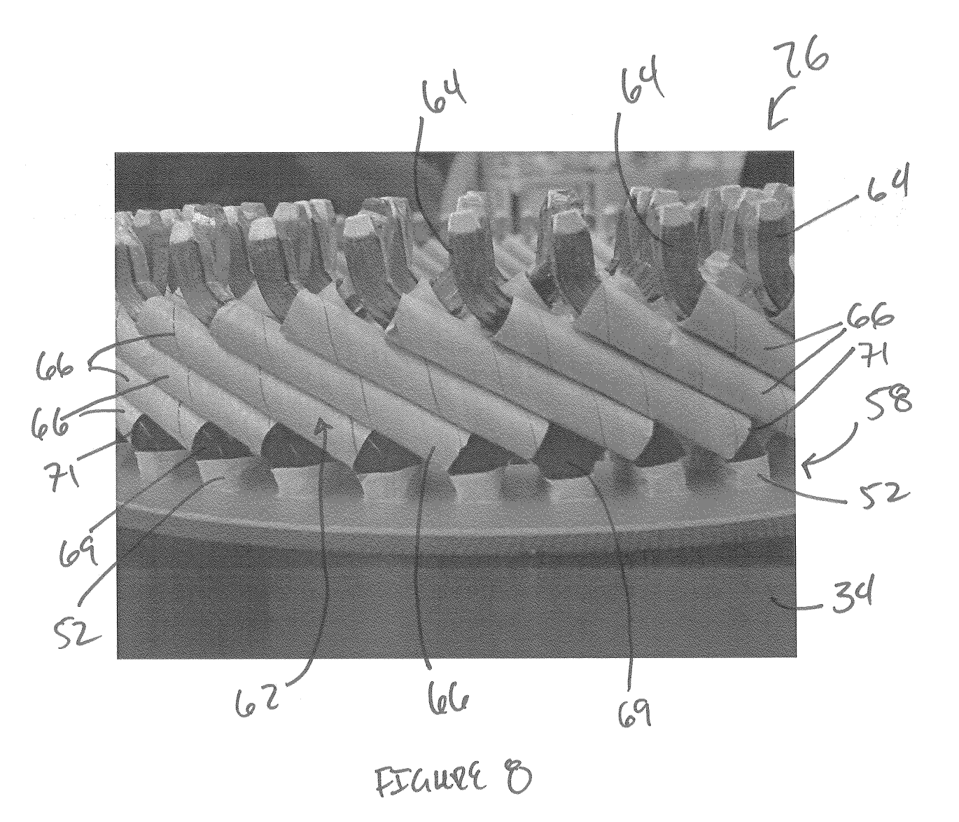

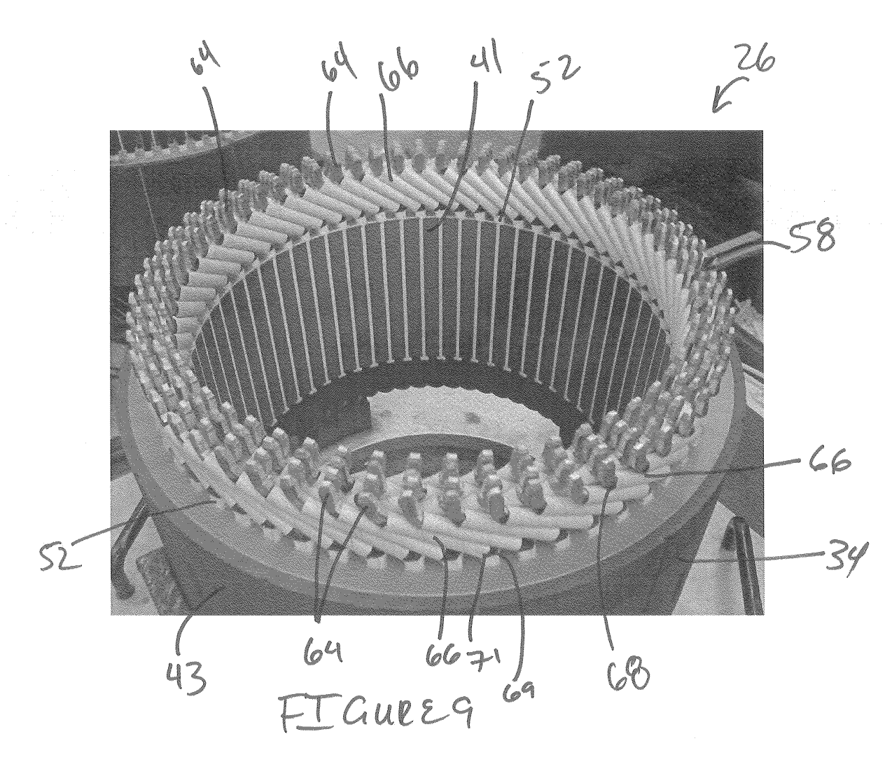

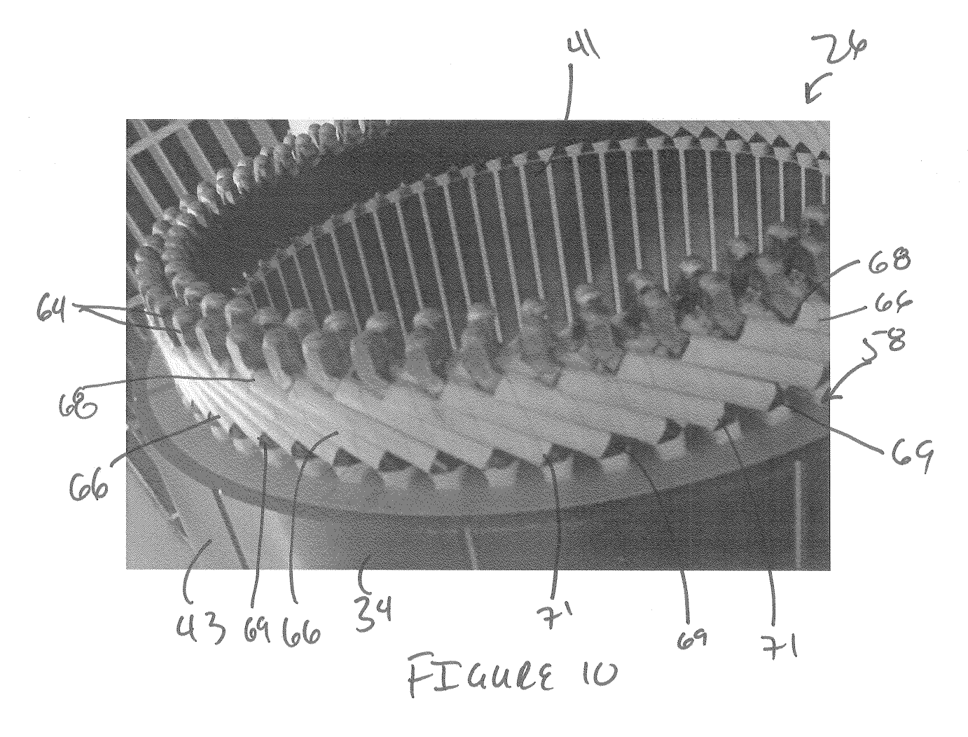

As shown in FIGS. 7 and 8, in some embodiments, at least a portion of the insulation members 66 can be positioned over (e.g., covering) a portion of at least some of the conductors 44 that will eventually comprise at least some of the angled portions 62. For example, in some embodiments, after inserting the conductors 44 within the stator core 34, insulation members 66 can be disposed over at least some of the leg portions 48 so that the insulation members 66 extend from a position substantially adjacent to the stator core 34 to a position substantially adjacent to the connection portions 64 (e.g., the insulation members 66 cover a portion of an axial length of some of the leg portions 48 axially extending from the stator core 34 and the connection portions 64 can be at least partially uncovered by the insulation members 66). In some embodiments, the length of at least some of the insulation members 66 can be configured so that after positioning the insulation members 66, the conductors 44 can be twisted, as previously mentioned, and the insulation members 66 can be disposed along the conductors 44 so that an axially outer edge 68 of at least a portion of the insulation members 66 can be disposed substantially adjacent to the connection portions 64, as shown in FIGS. 8-10. For example, the insulation members 66 can be disposed so that the angled portions 62 can be at least partially covered by the insulation members 66 and the connection portions 64 can be at least partially uncovered by the insulation members 66.

In some embodiments, four conductors 44 can be disposed in each slot 42 and four insulation members 66 can be positioned (e.g., automatically and/or manually) so that the insulation members 66 cover portions the four conductors 44 in each of the slots 42. After positioning the insulation members 66, the conductors 44 can be twisted into position and the connection portions 64 can be coupled together to form the stator winding 36. As a result, in some embodiments, the insulation members 66 can extend from a point substantially adjacent to the connection portions 64 to a point substantially adjacent to the stator core 34. For example, as shown in FIG. 7, in some embodiments, an exposed region 69 of at least a portion of the conductors of varying lengths can be defined between an axially inner edge 71 of at least a portion of the insulation members 66 and the stator core 34.

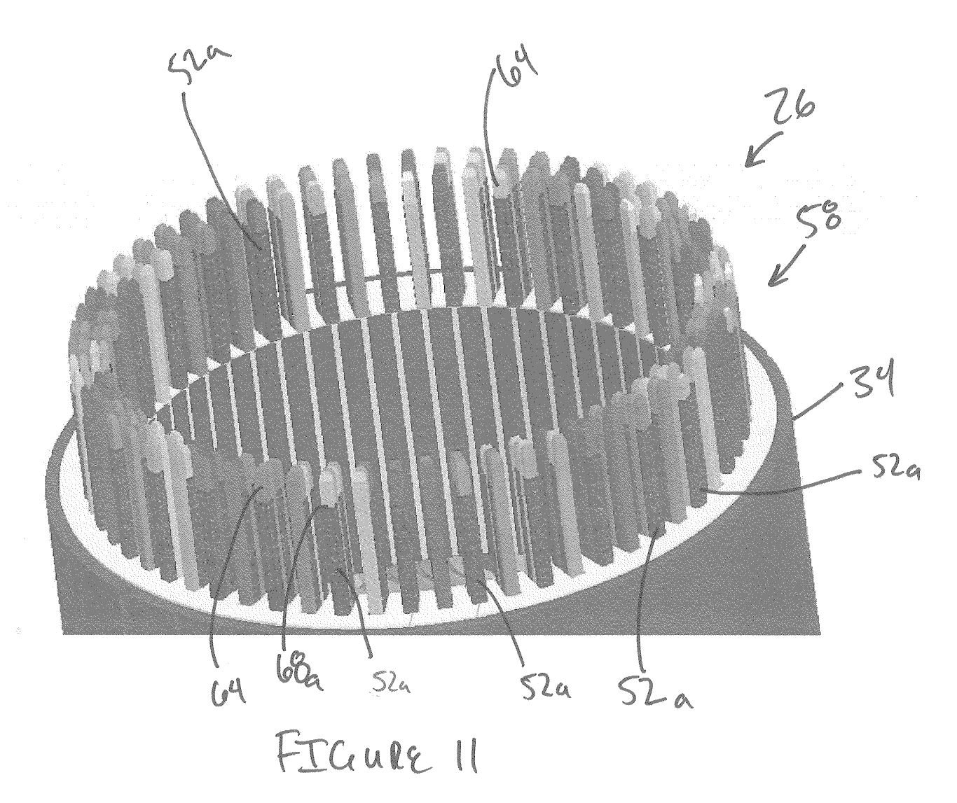

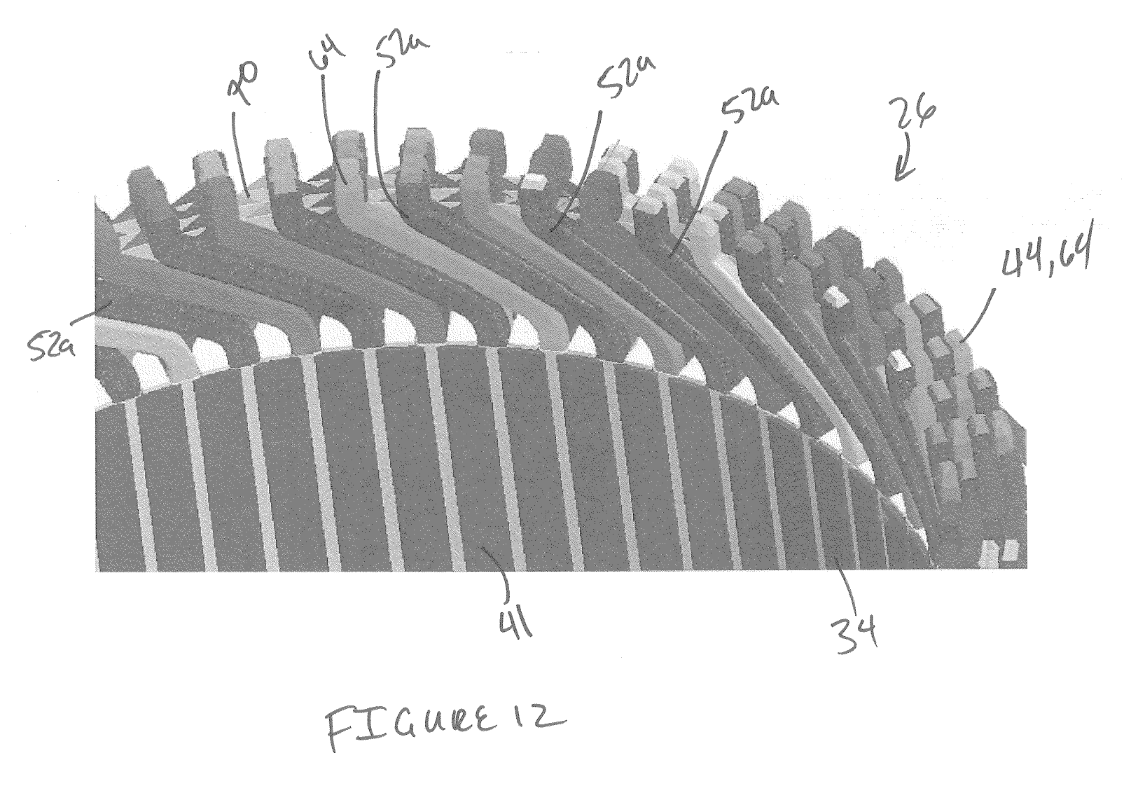

In some embodiments, other configurations can be employed. For example, in some embodiments, less than four conductors 44 can be disposed in the slots 42 (e.g., one, two, or three conductors 44), and less than four insulation members 66 can be used per slot 42 (e.g., one, two, or three insulation members 66). In some embodiments, at least a portion of the conductors 44 can function without insulation members 66. For example, as shown in FIGS. 11 and 12, in some embodiments, the insulation members 66 can be disposed over substantially alternating conductors 44 (e.g., around 50% of the conductors or every other conductor 44 can include insulation members 66) prior to twisting. In some embodiments, the insulation members 66 can be disposed so that some of the conductors 44 are not covered by the insulation members 66, however, neighboring conductors 44 include insulation members 66. As a result, at least some of the conductors 44 without insulation members 66 are immediately adjacent to conductors 44 with insulation members 66 to enhance protection of all of the conductors 44 (e.g., each of the conductors without an insulation member 66 is at least partially insulated by other conductors 44 with insulation members 66).

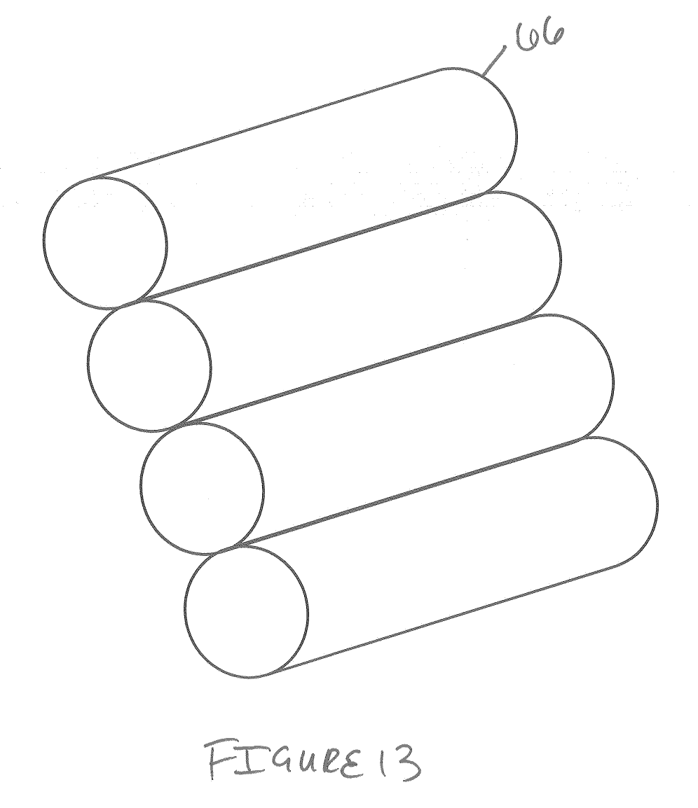

In some embodiments, at least a portion of the insulation members 66 can be configured and arranged to at least partially improve assembly of some portions of the module 10. In some embodiments, at least two insulation members 66 can be coupled together so that not as many individual insulation members 66 need to be disposed on and/or over the conductors 44. For example, two insulation members 66 can be coupled together (e.g., via an adhesive or other compound/material that can be reversibly coupled), as shown in FIG. 13, so that one set of insulation members 66 (e.g., two, three, or four insulation members 66 coupled together) can be positioned on adjacent (e.g., radially-adjacent) conductors 44. In some embodiments comprising more than two conductors 44 per slot 42, more than two insulation members 66 can be coupled together. For example, in some embodiments, four insulation members 66 can be coupled together so that a single set of insulation members 66 (i.e., the insulation members 66 coupled together) can be positioned on the four radially-adjacent conductors 44 disposed in the slots 42. In other embodiments, other numbers of insulation members 66 can be coupled together to at least partially ease assembly.

In some embodiments, as a result of coupling together at least a portion of the insulation members 66, assembly of the module 10 can be at least partially enhanced. For example, because the same numbers of insulation members 66 can be used but in fewer sets (e.g., one set can comprise multiple insulation members 66), greater numbers of insulation members 66 can be disposed on conductors 44 at any given time. Moreover, in order to facilitate fabrication of the stator assembly 26, in some embodiments, after being disposed on the conductors 44, the insulation members 66 that are coupled together can be configured and arranged to separate from each other without causing damage to the insulation members 66. For example, the insulation members 66 can be coupled together via an adhesive or other coupling material that can hold together at least two insulation members 66, however, the coupling bond between the coupled insulation members 66 can also be broken when the conductors 44 are twisted to form the angled portions 62 and the connection portions 64. As a result, the insulation members 66 can be disposed on the conductors 44 in sets of multiple insulation members 66 and can be uncoupled during the twisting process to give rise to the configurations illustrated in FIGS. 8-11. For example, at least a portion of the conductors 44 can be moved in a clockwise direction (e.g., about 50%) and another portion of the conductors 44 can be moved in a counter-clockwise direction (e.g., about 50%), which can lead to uncoupling of the insulation members 66.

In some embodiments, the insulation members 66 can be configured and arranged to provide insulative protection to at least a portion of the conductors 44. In some embodiments, portions of the conductors 44 disposed within the insulation members 66 (e.g., areas of the leg portions 48 and other portions of the conductors 44) can be protected from some of the previously mentioned difficulties associated with the twisting process and troubles that arise during the life of the module 10 and during the twisting process (e.g., conductors 44 contacting each other during the twisting process). For example, at least some of the insulation members 66 can insulate portions of the conductors 44 and first insulation 50 from at least a portion of the abrasion that occurs during the life of the module 10. Moreover, in some embodiments, the insulation members 66 can also provide dielectric protection for the conductors 44 (e.g., in addition to, or in lieu of, dielectric protection provided by the first insulation 50).

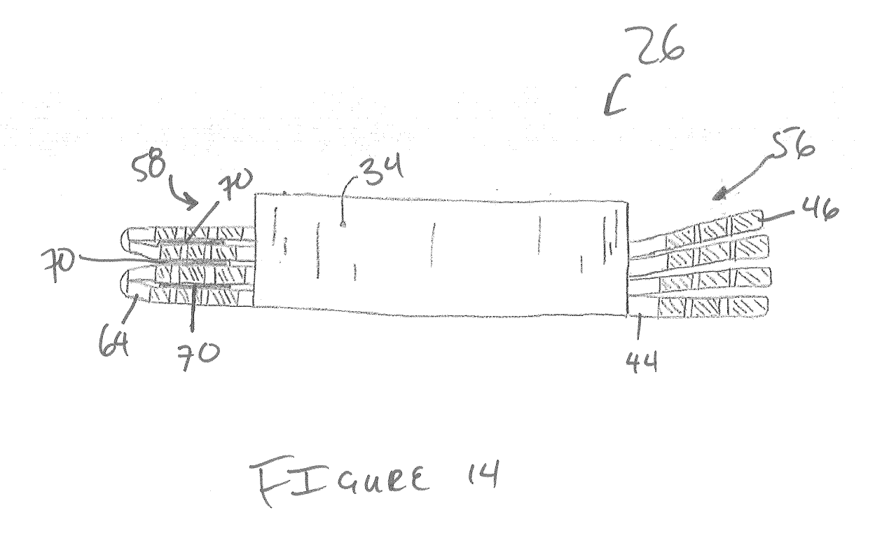

Some conventional electric machines can include an insulation band 70 positioned between adjacent leg portions 48 at the weld end side 58 of the stator assembly 26, as shown in FIG. 14. For example, in a conventional electric machine including four conductor leg portions 48 per slot, at least three insulation bands 70 can be positioned between adjacent leg portions 48 (e.g., each leg portion 48 can be layered immediately radially-adjacent to the next leg portion 48 and the insulation band 70 can be positioned between the leg portions 48), as shown in FIG. 14. The insulation bands 70 can extend in a circumferential direction between some or all of the leg portions 48 around at least a portion of the stator assembly 26.

The insulation bands 70 can serve to protect some portions of the conductors 44 that can be exposed during the coupling process. For example, both the conductors 44 and the first insulation 50 can be at least partially damaged by the coupling process (e.g., welding, brazing, etc.). The insulation bands 70 can be used in some conventional electric machines to reduce the damage during the coupling process because the bands 70 can shield, protect, and/or guard at least a portion of the conductors 44 and first insulation 50 from the harmful effects of the coupling process. In some embodiments, the insulation members 66 can at least partially reduce the need for some or all of the insulation bands 70. For example, in some embodiments, portions of the conductors 44 and the first insulation 50 positioned within the insulation members 66 can be protected from the coupling process by the insulation members 66 in lieu of the insulation bands 70 because of the physical separation provided by the insulation members 66. Accordingly, in some embodiments, inclusion of the insulation members 66 can reduce or eliminate the need for insulation bands 70.

In some embodiments, the insulation members 66 can comprise multiple configurations. In some embodiments, at least a portion of the slot members 52 can comprise some of the insulation members 66 as an extended slot member 52a. In some conventional stator assemblies, the slot members 52 can extend from a first axial distance (e.g., one to five millimeters) at both the weld end 58 and the insertion end 56. In some embodiments of the invention, the extended slot members 52a can comprise a second axial distance (e.g., a distance substantially similar to an axial length of the insulation members 66 combined with a length of the slot member 52) at the weld end 58 and/or the insertion end 56. As a result, after inserting the conductors 44 in the stator assembly 26, at least some of the leg portions 48 that extend from the stator core 34 can be disposed within the extended slot members 52a and can be insulated in a substantially similar manner to some of the previously mentioned embodiments.

Moreover, in some embodiments, the extended slot members 52a can be configured and arranged to extend a distance along at least some of the conductors 44 so that an axially outer edge 68a of the extended slot members 52a is substantially adjacent to the connection portions 64 and/or some areas of the turn portions 46. In some embodiments, the extended slot members 52a can be configured and arranged so that, after twisting, the axially outer edges 68a on the weld end 58 are substantially adjacent to the connection portions 64 to provide insulative benefits, as previously mentioned. In some embodiments, the extend slot liner 52a can provide additional insulative benefits because of its extended length. In some embodiments where the extended slot liner 52a extends to points substantially adjacent to the turn portion 46 and the connection portion 64, the conductors 44 can be at least partially insulated without a need for the first insulation 50. The need for the first insulation 50 can be reduced or eliminated because the extended slot liners 52a can be disposed over some or all of the conductors 44 (e.g., portions the leg portions 48 and the turn portions 46), which can be provide the insulation necessary for operations of the electric machine module 10.

Further, in some embodiments, after coupling the connection portions 64, at least a portion of the module 10 can be substantially coated in a second insulation (not shown). For example, in some embodiments, a varnish, a resinous material (e.g. an epoxy), another insulating material, or any combination thereof, can be applied to at least some portions of the electric machine 20 to provide an additional layer of insulation to at least partially reduce the chances of a short circuit and/or grounding events between electric machine module 10 components. In some embodiments, the second insulation can be applied by vacuum pressure impregnation, dipping, or other similar application methods. For example, in some embodiments, the second insulation (e.g., a resin, such as epoxy, a varnish, or other insulating material) can be applied to the stator assembly 26 via vacuum pressure impregnation in a manner substantially similar to the process disclosed in U.S. patent application Ser. No. 13/233,187, which is owned by the assignee of the present application and is incorporated herein by reference in its entirety. Regardless of the manner in which the second insulation is applied, the second insulation can permeate some or all of the stator assembly 26 (e.g., the slots 42, covering the conductors 44, any insulation, etc.). As a result, in some embodiments, after curing, the second insulation can function to both insulate the conductors 44 and couple together some or all of the portions of the stator assembly 26 (e.g., the cured varnish can be configured to permanently couple together portions of the stator assembly 26).

In some embodiments, the extended slot members 52a can be configured and arranged to enable coating of the stator assembly 26 of the second insulation. For example, some of the extended slot members 52a, the insulation members 66, and/or the slot members 52 can comprise materials that the second insulation cannot penetrate or they can comprise materials that the second insulation can only ineffectively or partially penetrate. As a result, in some embodiments, one or more of the extended slots liners 52a can comprise one or more insulation apertures 72. For example, the insulation apertures 72 can be disposed through portions of the extended slot members 52a at a position substantially adjacent to one or both of the ends 56, 58 of the stator assembly 26. As a result, at least a portion of the second insulation can enter the slots 42 and/or other portions of the stator assembly 26 via the insulation apertures 72 so that it can be cured and provide insulative and coupling benefits. In some embodiments, some of the insulation apertures 72 can be formed during manufacture of the extended slot members 52a and some of the insulation apertures 72 can be formed after manufacture of the extended slot members 52a (e.g., the apertures 72 can be formed after disposing the extended slot members 52a within the slots 42).

In some embodiments, the insulation apertures 72 can comprise multiple configurations. For example, one or more of the extended slot members 52a can comprise a plurality of insulation apertures 72 (e.g., the extended slot members 52a can comprise a generally perforated configuration). As result, the second insulation can penetrate the extended slot members 52a at multiple positions for any one extended slot member 52a. Moreover, in some embodiments, the plurality of insulation apertures 72 can be configured and arranged so that during the twisting process, the force of the movement of the conductors 44 and the extended slot members 52a can cause the outer portion of the members 52a to separate, which can lead to creation of the insulation members 66 and separate slot members 52.

In some embodiments, the insulation apertures 72 can be disposed on one or more sides of the extended slot members 52a. As previously mentioned, during the twisting process, the conductors 44 can be moved in multiple circumferential directions (e.g., about 50% of the conductors 44 can be moved in a clockwise direction and about 50% of the conductors 44 can be moved in a counter-clockwise direction). Accordingly, in some embodiments, the insulation apertures 72 can be disposed on a first side of the extended slot members 52a for leg portions 48 that are moved in a first circumferential direction (e.g., counter-clockwise) and on a second side that is substantially opposite the first side for leg portions 48 that are moved in a second circumferential direction (e.g., clockwise). As a result, the second insulation can enter the insulation apertures 72 at the opposite sides (e.g., alternating sides of the slot 42) for penetration into the stator assembly 26.

As shown in FIG. 1, in some embodiments, the sleeve member 14 can comprise a coolant jacket 74. For example, in some embodiments, the sleeve member 14 can include an inner wall 76 and an outer wall 78 and the coolant jacket 74 can be positioned substantially between the walls 76, 78. In some embodiments, the coolant jacket 74 can substantially circumscribe at least a portion of the electric machine 20. More specifically, in some embodiments, the coolant jacket 74 can substantially circumscribe at least a portion of an outer diameter of the stator assembly 26, including the stator winding 36 as it extends on both the insertion end 56 and the weld end 58 (e.g., the stator end turns 54).

Further, in some embodiments, the coolant jacket 74 can contain a coolant that can comprise transmission fluid, ethylene glycol, an ethylene glycol/water mixture, water, oil, motor oil, a mist, a gas, or another substance capable of receiving heat energy produced by the electric machine module 10. The coolant jacket 74 can be in fluid communication with a coolant source (not shown) which can pressurize the coolant prior to or as it is being dispersed into the coolant jacket 74, so that the pressurized coolant can circulate through the coolant jacket 74.

Also, in some embodiments, the inner wall 64 can include coolant apertures 80 so that the coolant jacket 74 can be in fluid communication with the machine cavity 22. In some embodiments, the coolant apertures 80 can be positioned substantially adjacent to the stator end winding 36 as it exits the stator core 34 on at least one of the weld end 58 and the insertion end 56. For example, in some embodiments, as the pressurized coolant circulates through the coolant jacket 74, at least a portion of the coolant can exit the coolant jacket 74 through the coolant apertures 80 and enter the machine cavity 22. Also, in some embodiments, the coolant can contact the stator winding 36, which can lead to at least partial cooling. After exiting the coolant apertures 80, at least a portion of the coolant can flow through portions of the machine cavity 22 and can contact various module 10 elements, which, in some embodiments, can lead to at least partial cooling of the module 10.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
a housing at least partially defining a machine cavity; and
an electric machine at least partially positioned within the machine cavity and at least partially enclosed by the housing, the electric machine including
a stator assembly including a stator core with a plurality of slots,
a plurality of conductors being positioned within at least a portion of the plurality of slots, the plurality of conductors each including at least one leg portion, the leg portions each including one or more angled portions and one or more connection portions, wherein the conductors are positioned within the plurality of slots so that one or more of the angled portions and one or more of the connection portions extend from the stator core at an end of the stator core, and
at least one insulation member being disposed over at least one of the leg portions extending from stator core so that at least one of the connection portions is at least partially uncovered by an insulation member and at least one of the angled portions is at least partially covered by the insulation member.

2. The electric machine module of claim 1, wherein at least a portion of the plurality of conductors comprise a first insulation.

3. The electric machine module of claim 1 and further comprising at least one slot member disposed within each of the plurality of slots, and wherein at least some of the leg portions are positioned within the slot members.

4. The electric machine module of claim 3, wherein at least a portion of the slot members are substantially integral with at least a portion of the insulation members.

5. The electric machine module of claim 1, wherein the insulation members extend from a position substantially adjacent to the connection portions to a position substantially adjacent to the stator core.

6. The electric machine module of claim 1, wherein each of the plurality of slots comprises at least four leg portions and each of the leg portions comprises at least one insulation member.

7. The electric machine module of claim 1, wherein each of the plurality of slots comprises at least four leg portions and at least two of the leg portions in each of the plurality of slots comprise at least one insulation member.

8. The electric machine module of claim 1, wherein the insulation members comprise at least one of Nomex®, Kapton®, Kevlar®, Mylar®, polyimides, polyamides, polyester, and polyamideimide.

9. The electric machine module of claim 1, wherein the insulation members are disposed over at least some turn portions.

10. The electric machine module of claim 1, and further comprising a coolant jacket at least partially disposed within the housing, and wherein the coolant jacket is in fluid communication with the machine cavity via a plurality of coolant apertures.

11. An electric machine module comprising:
a housing including a machine cavity; and
an electric machine at least partially positioned within the machine cavity, the electric machine including
a stator assembly including a stator core with a plurality of axially arranged slots, the stator assembly including a weld end and an insertion end,
at least one slot member being positioned within each of the slots,
a plurality of conductors positioned in the slots so that at least a portion of each of the conductors is disposed within the slot members, each of the conductors including a turn portion extending between two leg portions, the two leg portions including in-slot portions and connection portions, wherein the turn portions of the plurality of conductors axially extend from the insertion end and the connection portions axially extend from the in-slot portions at the weld end, and
a plurality of insulation members being disposed over at least one half of the leg portions extending from the stator assembly at the weld end, and wherein the plurality of insulation members are configured and arranged to extend from a point substantially adjacent to the connection portion to a point substantially adjacent to the stator core.

12. The electric machine module of claim 11, wherein the housing comprises a coolant jacket at least partially circumscribing a portion of the stator assembly.

13. The electric machine module of claim 11, wherein each of the plurality of slots comprises at least four leg portions and at least two of the leg portions include insulation members disposed over the leg portions that extend from the weld end.

14. The electric machine module of claim 13, wherein each of the leg portions is at least partially disposed within one or more of insulation members.

15. The electric machine module of claim 14, wherein at least two of the insulation members are reversibly coupled together.

16. The electric machine module of claim 11, wherein at least some of the insulation members are substantially integral with at least some of the slot members.

17. A method of assembling a stator assembly, the method comprising:
providing a plurality of stator laminations including a plurality of teeth;
coupling together at least a portion of the plurality of stator laminations so that the plurality of teeth substantially axially align to form a plurality of slots and the laminations form a stator core, wherein the stator core includes an insertion end and a weld end;
disposing at least one slot member within each of the plurality of slots;
inserting a plurality of conductors into the plurality of slots so that a first portion of at least some of the plurality of conductors extends in an axially outward direction from the insertion end of the stator core and a second portion of at least some of the plurality of conductors extends in an axially outward direction from the weld end of the stator core, and wherein at least a portion of some of the plurality of conductors is disposed within the slot members; and
positioning one or more insulation members over at least some of the second portions extending from the weld end so that a first region of the second portions remains uncovered and a second region of the second portions is within the insulation members.

18. The method of claim 17 and further comprising moving the second portion of at least some of the plurality of conductors to create a connection portion and an angled portion on the moved conductors.

19. The method of claim 18, wherein the connection portion comprises the first region and the angled region comprises the second region.

20. The method of claim 17, wherein each of the second portions includes one or more insulation members.

21. The method of claim 17, wherein each of the plurality of slots comprises at least four conductors and least two of the conductors in each of the plurality of slots comprise the insulation members.

22. The method of claim 17, wherein the insulation members comprise at least one of Nomex®, Kapton®, Kevlar®, Mylar®, polyimides, polyamides, polyester, and polyamideimide.

23. The method of claim 17 and further comprising coating at least a portion of the conductors, stator core, slot members, and insulation members in an insulation.

24. The method of claim 23, wherein the insulation comprises a varnish.

25. An electric machine module comprising:
a housing including a machine cavity; and
an electric machine at least partially positioned within the machine cavity, the electric machine including
a stator assembly with a plurality of slots, the stator assembly including a weld end and an insertion end,
at least one slot member being positioned within each of the slots,
a plurality of conductors being disposed in at least some of the plurality of slots so that the conductors are at least partially disposed within the slot members, the plurality of conductors including a first portion extending from the weld end and a second portion extending from the insertion end, the first portion comprising at least a connection portion and an angled portion, and wherein at least one half of the slot members are configured and arranged to extend from a point substantially adjacent to the connection portions to a point substantially adjacent to the second portions of the plurality of conductors.

26. The electric machine module of claim 25 and further comprising at least one aperture being disposed through at least some of the slot members.

27. The electric machine module of claim 25 and further comprising a plurality of apertures being disposed through at least some of the slot members.

28. The electric machine module of claim 25, wherein all of the slot members are configured and arranged to extend from a point substantially adjacent to the connection portions to a point substantially adjacent to the second portions of the plurality of conductors.

29. The electric machine module of claim 25, wherein the second portions comprise turn portions.

30. The electric machine module of claim 29, wherein at least some of the slot members are configured and arranged to at least partially cover the turn portions.

31. The electric machine module of claim 29, wherein at least some of the turn portions comprise one or more insulation members.

32. The electric machine module of claim 25, wherein the slot members comprise at least one of Nomex®, Kapton®, Kevlar®, Mylar®, polyimides, polyamides, polyester, and polyamideimide.

33. The electric machine module of claim 25, wherein at least some of the slot members comprise a perforation so that at least some of the slot members to be divided into an in-slot portion and an insulation member upon an application of force to the conductors.

34. The electric machine module of claim 25, wherein the housing comprises a coolant jacket at least partially circumscribing a portion of the stator assembly, and wherein the coolant jacket is in fluid communication with the machine cavity via a plurality of coolant apertures.

35. An electric machine module comprising:
a housing at least partially defining a machine cavity; and
an electric machine at least partially positioned within the machine cavity and at least partially enclosed by the housing, the electric machine including
a stator assembly including a stator core with a plurality of slots,
a plurality of conductors being disposed in at least some of the plurality of slots, each of the plurality of conductors including a first portion extending from a weld end of the stator core and a second portion extending from an insertion end of the stator core, the first portion comprising at least a connection portion and an angled portion, the second portion comprising at least a turn portion, and wherein at least one insulation member is disposed over a region of the second portion of at least one of the plurality of conductors so that the insulation member extends from a point substantially adjacent to the turn portion to a point substantially adjacent to the stator core.

36. The electric machine module of claim 35, wherein at least one insulation member is disposed over a region of the first portion of at least one of the plurality of conductors so that the insulation member extends from a portion substantially adjacent to the connection portion to a point substantially adjacent to the stator core.

37. The electric machine module of claim 36, wherein the angled portion of the conductor is substantially covered by the insulation member.

38. The electric machine module of claim 35, wherein the second portion of at least one half of the plurality of conductors comprises at least one insulation member.

39. The electric machine module of claim 35, wherein the second portion of at least a portion of the plurality of conductors comprises at least two insulation members.

40. The electric machine module of claim 39, wherein the first portion of at least a portion of the plurality conductors comprises at least one insulation member.

41. The electric machine module of claim 35 and further comprising at least one slot member disposed in at least one of the plurality of slots, and wherein the at least one slot member is coupled to the at least one insulation member.

42. The electric machine module of claim 41, wherein the at least one slot member is configured and arranged to extend from a point substantially adjacent to the connection portion.
